(19) United States
(12) Patent Application Publication
(10) Pub. No.: US 2018/0288965 A1
(43) Pub. Date: Oct. 11, 2018

(54) Dog accessories case

(71) Applicant: David Berry, Buena, NJ (US)

(72) Inventor: David Berry, Buena, NJ (US)

(21) Appl. No.: 15/480,155

(22) Filed: Apr. 5, 2017

(51) Int. Cl. A01K 5/01; A01K 29/00; A01K 7/00; B65D 33/06; B65D 43/02; B65D 33/00

(52) U.S. Cl. CPC A01K 5/0107; A01K 29/00; A01K 5/0135; B65D 33/004; B65D 33/06; B65D 43/0204; A01K 7/005

(57) ABSTRACT

A dog accessories case that features a dog bone-shaped bag making the process of feeding and hydrating pets as well as transporting essentials. The dog accessories case includes a dog bone-shaped bag includes a top portion, the dog bone-shaped bag contains one or more dog accessories, a pair of bowls disposed on the top portion of the dog bone-shaped bag, a storage area disposed on a middle portion of the top portion of the dog bone-shaped bag, a plurality of hinges disposed on a plurality of back edges of the top portion of the dog bone-shaped bag and are used to open and close the top portion of the dog bone-shaped bag, a plurality of snaps disposed on a plurality of front edges of the top portion of the dog bone-shaped bag and to secure and release the top portion of the dog bone-shaped bag and a bone-shaped handle.

### BACKGROUND OF THE INVENTION

### Field of the Invention

The present invention is a case. More specifically, the present invention is a dog accessories case.

### Description of the Related Art

Currently, there are no feasible travel cases on the market for dogs that include compartments for food and water storage as well as an area to hold leashes in place. Usually the only alternative to feeding pets while one is mobile is to attempt to do it in the car which can be very messy or pulling over at a rest stop which can be time-consuming and inconvenient.

What is needed is a dog accessories case that features a fully portable case for canines making the process of feeding and hydrating pets as well as transporting essentials as seamless and hassle-free as possible regardless of location.

### SUMMARY OF THE INVENTION

The present invention is a case. More specifically, the present invention is a dog accessories case.

The dog accessories case includes a dog bone-shaped bag includes a top portion, the dog bone-shaped bag contains one or more dog accessories, a pair of bowls disposed on the top portion of the dog bone-shaped bag, a storage area disposed on a middle portion of the top portion of the dog bone-shaped bag edges of the top.

It is an object of the present invention to provide a dog accessories case that features a fully portable case for canines making the process of feeding and hydrating pets as well as transporting essentials as seamless and hassle-free as possible regardless of location.

It is an object of the present invention to provide a dog accessories case that it is manufactured of a brand name of plastic containers, used especially for food preparation and storage or TUPPERWARE® for added durability and flexibility.

It is an object of the present invention to provide a dog accessories case that is also completely dishwasher friendly ensuring optimal functionality every time even after repeated washes.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates an overhead view of a dog accessories case, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention however the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

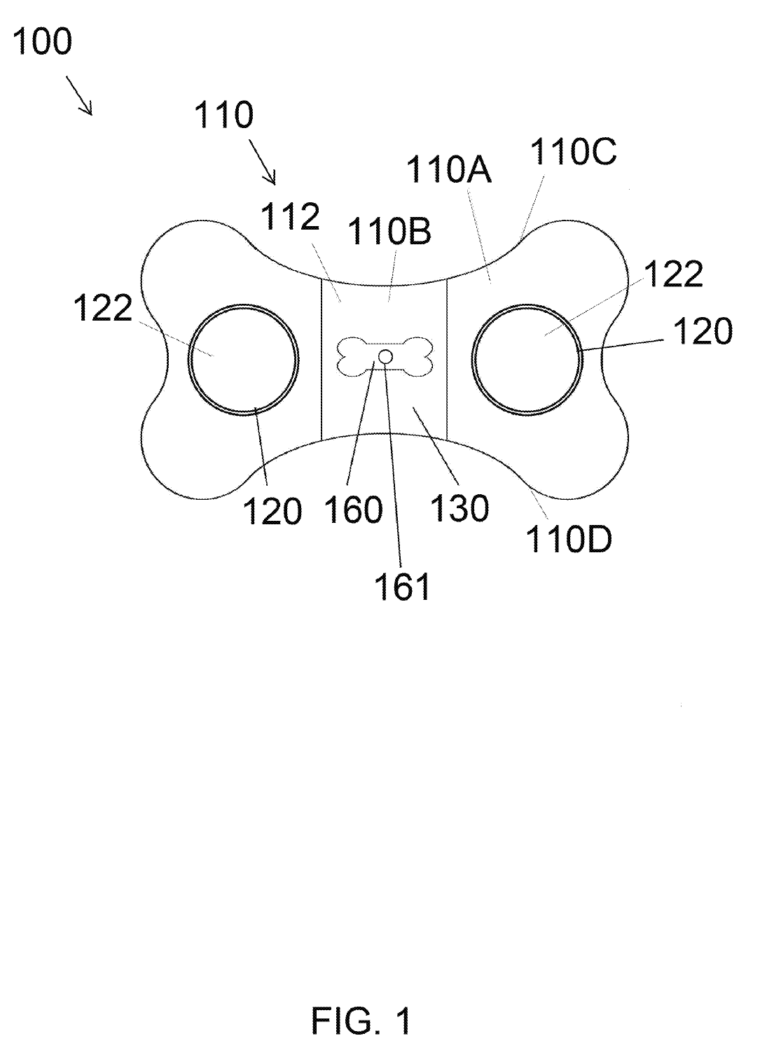

FIG. 1 illustrates an overhead view of a dog accessories case 100, in accordance with one embodiment of the present invention.

The dog accessories case 100 includes a dog bone-shaped bag 110, a pair of bowls 120, a storage area 130 and a bone-shaped handle 160. The bone shaped handle 160 includes a hole 161 for a dog I D tag.

The dog bone-shaped bag 110 may include a top portion 110A. The dog bone-shaped bag 110 may contain one or more dog accessories 112 such as a leash, dog treats and other suitable dog accessories. The pair of bowls 120 may be disposed on the top portion 110A of the dog bone-shaped bag 110. More specifically, each of the pair of bowls 120 may be disposed on each side of the top portion 110A of the dog bone-shaped bag 110. The storage area 130 may be disposed on a middle portion 1108 of the top portion 110A of the dog bone-shaped bag 110. The storage area 130 may be approximately 4 inches deep or other suitable depth. Optionally hinges may be disposed on a plurality of back edges 110C of the top portion 110A of the dog bone-shaped bag 110 and are used to open and close the top portion 110A of the dog bone-shaped bag 110. Optionally snaps may be disposed on a plurality of front edges 110D of the top portion 110A of the dog bone-shaped bag 110 and are used to secure and release the top portion 110A of the dog bone-shaped bag 110. The bone-shaped handle 160 may be disposed on top of the storage area 130 and may be used to transport the dog bone-shaped bag 110. The bone-shaped handle 160 may provide an aestetic appeal to the dog bone-shaped bag 110.

The dog accessories case 100 is comprised of a dog bone shaped bag 110 measuring approximately 18 inches long×8 inches wide×4 inches deep, a top portion 110A, a bone-shaped handle 160, a storage area 130 disposed on a middle portion 1108 of the top portion 110A of the dog bone-shaped bag 110 and a pair of 16 oz. bowls 120 with a snap on lid 122. Easy to use, fill the bowls 120 with food or water as desired, affix snap on lids 122 on each bowl 120, place leash or treats as desired in storage area 130, and utilize the bone-shaped handle 160 to transport case from one location to another as needed. The dog accessories case 100 is essential for the everyday consumer and may be readily available in all retail pet stores and pet accessory stores.

While the present invention has been related in terms of the foregoing embodiments those skilled in the art will recognize that the invention is not limited to the embodiments described. The present invention may be practiced with modification and alteration within the spirit and scope of the appended claims. Thus, the description is to be regarded as illustrative instead of restrictive on the present invention.

What is claimed is:

1. A dog accessories case, comprising:
a dog bone-shaped bag includes a top portion, the dog bone-shaped bag contains one or more dog accessories;
a pair of bowls disposed on the top portion of the dog bone-shaped bag;
a storage area disposed on a middle portion of the top portion of the dog bone-shaped bag; and
a bone-shaped handle disposed on top of the storage area and are used to transport the dog bone-shaped bag to provide an aesthetic appeal to the dog bone-shaped bag, the bone shaped handle has a hole for a dog I D tag.

2. The dog accessories case according to claim 1, wherein each of the bowls have a snap-on lid.

3. The dog accessories case according to claim 1, wherein the storage area is 4 inches deep.

4. The dog accessories case according to claim 1, wherein the dog bone shaped bag measuring 18 inches long×8 inches wide×4 inches deep.
